(19) United States
(12) Patent Application Publication
(10) Pub. No.: US 2009/0182615 A1
(43) Pub. Date: Jul. 16, 2009

(54) SELF-SERVE DIRECT-TO-CONSUMER MAIL MARKETING SERVICE

(75) Inventor: Samarth Sharath Pai, Bellevue, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/013,472

(22) Filed: Jan. 14, 2008

(51) Int. Cl. G06Q 30/00; G06F 3/048

(52) U.S. Cl. 705/10; 715/764

(57) ABSTRACT

Technologies are described herein for providing a self-serve direct-to-consumer mail marketing service. A unified mail marketing service is provided through which a user can generate a postal or e-mail mailing without the need to consult multiple independent service providers. The mail marketing service provides a single point of contact for creating demographics, identifying potential customers that satisfy the demographics, creating the mailing, creating and monitoring points of contact to measure the success of the mailing, and for printing and sending the mailing.

### BACKGROUND

Businesses frequently utilize postal and electronic mail (“e-mail”) marketing campaigns in an effort to acquire new customers. A postal mail marketing campaign typically involves creating and sending a physical mailing containing an advertisement through the postal service to the physical address of a potential customer. An e-mail marketing campaign typically involves creating and sending e-mail messages containing an advertisement to the e-mail addresses of potential customers.

In order to implement a postal or e-mail marketing campaign, a business must perform a number of separate and distinct tasks. For instance, in order to implement a successful postal or e-mail marketing campaign, a business must decide upon the demographics to target with the mailing, obtain a list of potential customers that meet the demographics and that reside within a relevant trade area, create the physical or electronic mailing for the campaign, create points of contact to measure the success of the mailing, print the mailing in the case of a postal mail campaign, and send the mailing through the postal service or electronic means.

It is often difficult for businesses, and especially small businesses, to generate a postal or e-mail marketing campaign using the process described above. This difficulty stems mainly from the fact that each step of the process requires collaboration with a different service provider. For instance, a business may need to consult with one service provider to decide upon the appropriate demographics. The business may need to consult with a second service provider in order to obtain a list of potential customers that meet the demographics. The business may need to consult with other providers to create the mailing, to create and monitor points of contact to measure the success of the campaign, and to print and send the mailing. Consulting with multiple independent service providers in this manner can be a time-consuming, complicated, expensive, and sometimes frustrating process for businesses wishing to create and send a mailing to a targeted set of potential customers.

It is with respect to these considerations and others that the disclosure made herein is presented.

### SUMMARY

Technologies are described herein for providing a self-serve direct-to-consumer mail marketing service. In particular, a unified mail marketing service is provided herein through which a user can generate a postal or e-mail mailing without the need to consult multiple independent service providers. The mail marketing service provides a single point of contact for creating demographics, identifying potential customers that satisfy the demographics, creating the mailing, creating and monitoring points of contact to measure the success of the mailing, and for printing and sending the mailing. This greatly simplifies the process of creating and monitoring the success of a mailing for a business owner.

According to one implementation presented herein, the self-serve direct-to-consumer mail marketing service comprises a World Wide Web (“Web”) site through which a user can define and send a mailing. As used herein, the term “mailing” refers collectively to one or more pieces of physical mail that are sent via the postal service or one or more e-mail messages that are sent electronically. According to embodiments, the mailing includes a marketing message for a business on behalf of which the mailing is sent. For instance, the mailing may include content such as a marketing message and a call to action for the recipient of the mailing. The call to action suggests to the recipient of the mailing the desired action to be taken (e.g. “Call Us To Place Your Order”).

According to other aspects, the service provides a guided user interface for defining, implementing, and monitoring the effectiveness of a mailing. For instance, a user interface may be provided for specifying information about the business on behalf of which the mailing is to be sent. The information may include contact information for the business, geographic information for potential customers of the business, and the identity of one or more categories to which the business belongs. Based upon the information received through the user interface about the business, the service generates demographic data corresponding to the potential customers of the business. Potential customers of the business are then identified using the demographic data. A user may be permitted to modify the demographic data.

According to additional aspects, a user interface is also provided through which a user can specify a layout and content for the mailing. For instance, in one implementation, a user is presented with a user interface for selecting a pre-Microsoft formed template for the mailing. The template may include a pre-defined marketing message and call to action suitable for the business. A user can modify the template or create the mailing and its content without the use of a pre-formed template. Once the mailing has been created, another user interface may be provided for defining a schedule for sending the mailing.

According to other aspects, another user interface may be provided for defining a unique point of contact for the mailing. For instance, according to embodiments, the unique point of contact may comprise a unique telephone number or Web address associated with the mailing. The unique point of contact is monitored to determine the number of responses to the mailing. The phone number may be monitored to determine the number of calls received in response to the mailing and the Web address may be monitored to determine the number of requests received for the Web address in response to the mailing. A user interface may be provided for delivering data to a user indicating the number of responses to the mailing made through the unique point of contact.

Once a user has defined the mailing, the system provided herein is configured to send the mailing to the potential customers based upon the schedule. In the case of a physical mailing, the mailing is printed using the specified layout and content. The mailing is then sent to the potential customers through the postal service. In the case of an e-mail mailing, the e-mail messages are created with the specified layout and content, and then transmitted to the potential customers electronically.

It should be appreciated that the above-described subject matter may also be implemented as a computer-controlled apparatus, a computer process, a computing system, or as an article of manufacture such as a computer-readable medium. These and various other features will be apparent from a reading of the following Detailed Description and a review of the associated drawings.

This Summary is provided to introduce a selection of concepts in a simplified form that are further described below in the Detailed Description. This Summary is not intended to identify key features or essential features of the claimed subject matter, nor is it intended that this Summary be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a network diagram showing aspects of an illustrative operating environment and several software components provided by the embodiments presented herein;

FIG. 2 is a flow diagram showing one illustrative process disclosed herein for providing a self-serve direct-to-consumer mail marketing service;

FIG. 3 is a screen diagram showing aspects of an illustrative user interface for providing an overview of one process for creating a mailing using the mail marketing service provided herein;

FIGS. 4A-4C are screen diagrams showing aspects of an illustrative user interface for specifying information about a business that is sending a mailing using the mail marketing service presented herein;

FIGS. 5A-5C are screen diagrams showing aspects of an illustrative user interface for displaying demographic data and for modifying the demographic data in one implementation presented herein;

FIGS. 6A-6D are screen diagrams showing aspects of an illustrative user interface for specifying a unique point of contact for customers responding to a mailing created using the mail marketing service presented herein;

FIGS. 7A-7D are screen diagrams showing aspects of an illustrative user interface for specifying the content of a mailing in one implementation presented herein;

FIG. 8 is a screen diagram showing aspects of an illustrative user interface for scheduling the sending of a mailing through the mail marketing service presented herein in one implementation;

FIG. 9 is a screen diagram showing aspects of an illustrative user interface for providing a summary of a mailing created using the mail marketing service provided in embodiments presented herein;

FIG. 10 is a screen diagram showing aspects of an illustrative user interface for monitoring the effectiveness of a mailing generated using the mail marketing service presented herein; and

FIG. 11 is a computer architecture diagram showing an illustrative computer hardware and software architecture for a computing system capable of implementing aspects of the embodiments presented herein.

### DETAILED DESCRIPTION

The following detailed description is directed to technologies for providing a self-serve direct-to-consumer mail marketing service. In the following detailed description, references are made to the accompanying drawings that form a part hereof, and which are shown by way of illustration specific embodiments or examples. Referring now to the drawings, in which like numerals represent like elements throughout the several figures, aspects of a computing system and methodology for providing a self-serve direct-to-consumer mail marketing service will be described.

While the subject matter described herein is presented in the general context of program modules that execute in conjunction with the execution of an operating system and application programs on a computer system, those skilled in the art will recognize that other implementations may be performed in combination with other types of program modules. Generally, program modules include routines, programs, components, data structures, and other types of structures that perform particular tasks or implement particular abstract data types. Moreover, those skilled in the art will appreciate that the subject matter described herein may be practiced with other computer system configurations, including hand-held devices, multiprocessor systems, microprocessor-based or programmable consumer electronics, minicomputers, mainframe computers, and the like.

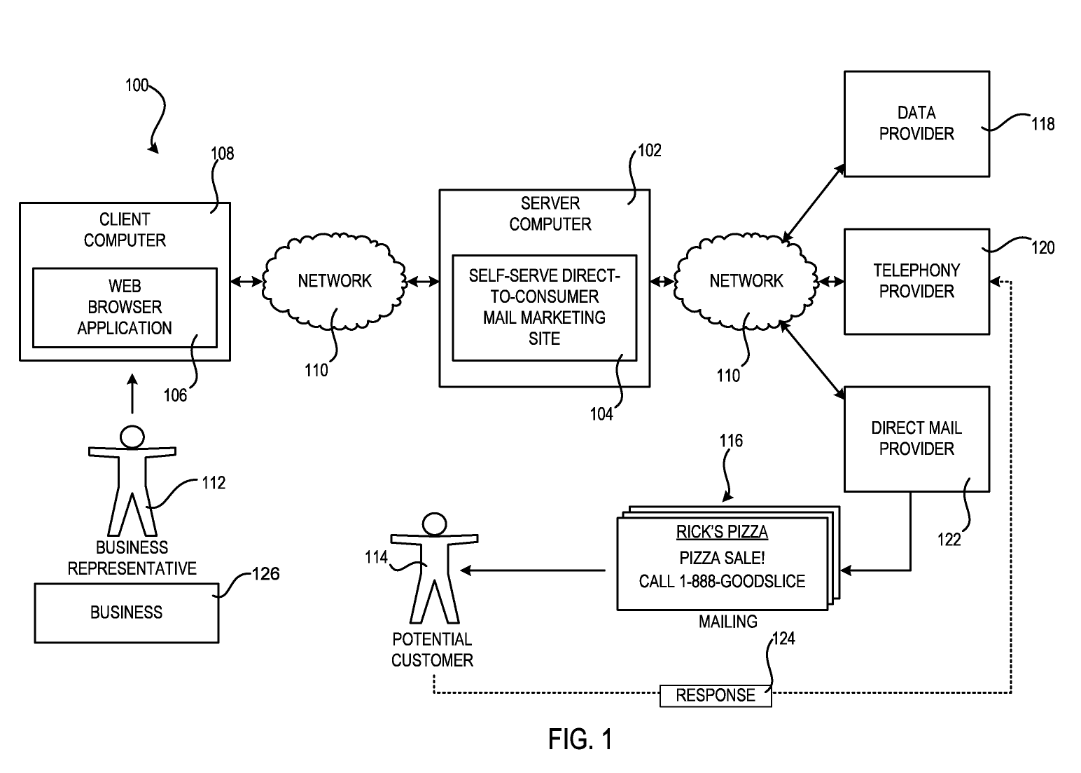

Turning now to FIG. 1, details will be provided regarding an illustrative operating environment and several software components provided by the embodiments presented herein. In particular, FIG. 1 shows aspects of a system 100 capable of providing functionality for sending a mailing 116. As mentioned above, the term mailing as used herein refers collectively to one or more pieces of physical mail that are sent via the postal service or one or more e-mail messages that are sent electronically. According to embodiments, the system 100 includes a client computer 108 and a server computer 102. As illustrated in FIG. 1, the client computer 108 and the server computer 102 are interconnected through one or more local and wide area networks, such as the network 110. It should be appreciated that many more network connections may be utilized than illustrated in FIG. 1.

In one embodiment, the client computer 108 illustrated in FIG. 1 comprises a standard desktop or laptop computer system capable of executing an operating system and one or more application programs. It should be appreciated, however, that in other embodiments the client computer 108 comprises another type of computing device. For instance, according to embodiments, the client computer 108 may comprise a mobile computing device such as a mobile telephone, a smart phone, an ultra-mobile personal computer, a tablet personal computer, or another type of mobile computing device. Other devices may also be utilized in a similar manner.

According to embodiments the client computer 108 is operative to execute a Web browser application program 106 (“Web browser”). Through the Web browser 106, a user of the client computer 108 can access the self-serve direct-to-consumer mail marketing Web site 104 (“the “Web site”). The Web site 104 is a server-based application that provides a unified mail marketing service through which a user of the client computer 108, such as the business representative 112, can generate a postal or e-mail mailing 116 for a business 126 without the need to consult multiple independent service providers. As will be described in greater detail below, the mail marketing service provided by the Web site 104 provides a single point of contact for creating demographics, identifying potential customers 114 of the business 126 that satisfy the demographics, creating the mailing 116, creating and monitoring points of contact to measure the success of the mailing 116, and for printing and sending the mailing 116. This greatly simplifies the process of creating and monitoring the success of a mailing 116 for a business 126 and its representative 112.

It should be appreciated that although the Web site 104 is described herein as being accessible through the public Internet, the Web site 104 may also be made available on a private internal Web site. Moreover, the Web site 104 may be accessible through a Web browser 106 as described herein or through the use of another client application capable of receiving and rendering the Web site 104. It should also be appreciated that the functionality described herein as being provided by the Web site 104 may be provided by another type of online or offline service. For instance, the functionality described herein as being provided by the Web site 104 may be integrated into a stand-alone application program capable of executing on a network-connected client computer.

The server computer 102 provides the Web site 104 described herein. The server computer 102 comprises a standard server computer system capable of executing an operating system and one or more other programs. In particular, in the embodiments presented herein the server computer 102 executes a Web server application (not shown) that is configured to receive and respond to requests for the Web site 104 and its component resources from the Web browser 106. In this regard, the Web site 104 may utilize graphics, hypertext markup language (“HTML”), extensible markup language (“XML”), JAVASCRIPT, asynchronous JAVASCRIPT (“AJAX”), and other types of visual and programmatic resources not explicitly shown in the FIGURES.

In order to enable the unified functionality described herein, the server computer 102 may communicate with computing systems provided by third-party service providers. For instance, as shown in FIG. 1, the server computer 102 may communicated with a data provider 118 via the network 110. The data provider 118 provides the functionality described herein for identifying demographics for the business 126. For instance, as will be discussed in greater detail below, the data provider 118 may receive information about the business 126, such as its contact information, geographic location, and a category of business to which it belongs and, based upon this information, generate appropriate demographics for the potential customers 114 of the business 126. According to other embodiments, the data provider 118 may further provide contact information, such as a name and an address for a physical or electronic mailing, for the potential customers 114. As will be described in greater detail below, this information is utilized by the Web site 104 to send the mailing to the potential customers 114.

According to other embodiments, the server computer 102 may communicate with a third-party provider to create, utilize, and monitor unique points of contact for a mailing. A unique point of contact is a mechanism for contacting the business 126 that is uniquely associated with a mailing 116. For instance, as shown in FIG. 1, the server computer 102 may communicate with a telephony provider 120 to create, utilize, and monitor a unique point of contact for a mailing 116 in the form of a unique telephone number associated with a mailing.

In response to instructions received from the server computer 102, the telephony provider 120 may create the unique telephone number associated with a mailing 116 (e.g. 1-888-GOODSLICE). The unique telephone number is included with the mailing 116. Responses 125 to the mailing in the form of calls to the unique telephone number are forwarded to the business 126. The telephony provider 120 also monitors calls to the unique telephone number to determine the number of responses to the mailing 116. This information is indicative of the effectiveness of the mailing 116 and is provided to the creator of the mailing 116 through a user interface provided by the Web site 104.

According to embodiments, the Web site 104 may also provide functionality for creating, utilizing, and monitoring a unique point of contact in the form of a unique Web address. For instance, in this example a unique Web address may be provided for responding to the mailing 116. The Web address is included with the mailing 116. Responses to the mailing, in the form of requests for the unique Web address, are monitored to determine the effectiveness of the mailing 116. Statistics may be provided to the creator of the mailing 116 regarding the number of requests for the unique Web page associated with the mailing 116 from which the effectiveness of the mailing 116 can be inferred. Additional details regarding a user interface for creating a unique point of contact for a mailing 116 will be provided below.

The server computer 102 may also communicate with a direct mail provider 122. The direct mail provider 122 provides functionality for printing and sending a postal mailing 116. In this regard, the server computer 102 may transmit the contact information for the potential customers 114 along with the content and layout for the mailing 116. In response to receiving this data, the direct mail provider 122 prints the physical mailing and sends the mailing to the potential customers 114 via the postal service. The direct mail provider 122 may also send an electronic mailing in a similar manner. Alternatively, the provider of the Web site 104 may send an electronic mailing 116 without the assistance of a third-party direct mail provider 122. It should be appreciated that the functionality described herein as being performed by the data provider 118, the telephony provider 120, and the direct mail provider 122, may be provided by fewer or more third-party providers or by the operator of the Web site 104.

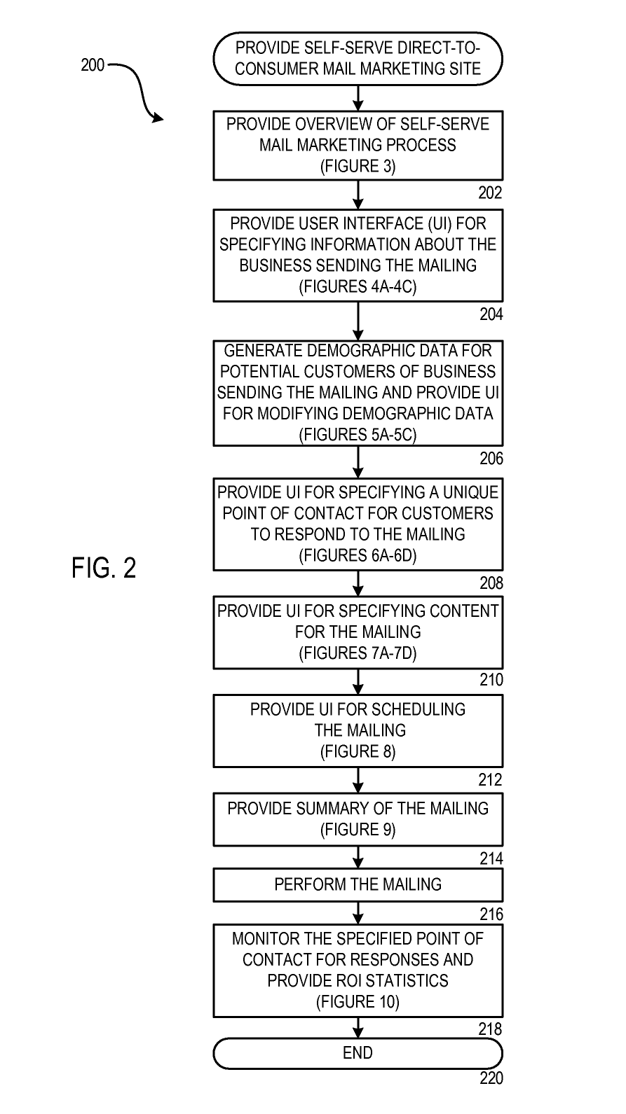

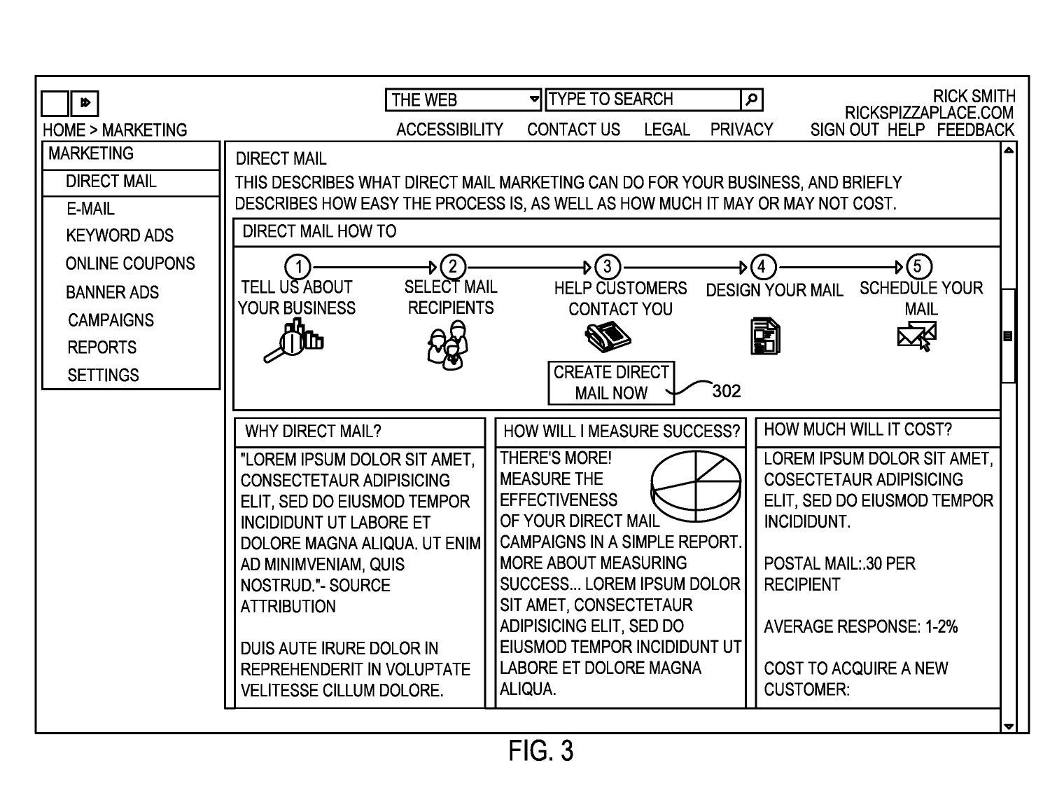

Referring now to FIG. 2, a routine 200 will be described that illustrates the operation of the Web site 104 in one implementation provided herein. The routine 200 will be described in conjunction with FIGS. 3-10, which are screen diagrams that illustrate various user interfaces provided by the Web site 104 for generating a mailing 116 in one embodiment. In this regard, the screen diagrams shown in FIGS. 3-10 illustrate a rendering of the Web site 104 generated by the Web browser 106. It should be appreciated that the user interface controls shown in these screen diagrams and described herein are merely illustrative and that any suitable user interface control or screen layout may be utilized.

It should also be appreciated that the logical operations described herein are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states operations, structural devices, acts, or modules. These operations, structural devices, acts and modules may be implemented in software, in firmware, in special purpose digital logic, and any combination thereof. It should also be appreciated that more or fewer operations may be performed than shown in the figures and described herein. These operations may also be performed in a different order than those described herein.

The routine 200 begins at operation 202, where an overview of the self-serve mail marketing process provided by the Web site 104 is provided. The overview is optional but may assist a user in understanding the process provided by the Web site 104 for creating a mailing 116. The screen display illustrated in FIG. 3 shows one example of an overview that is provided by the Web site 104 in one embodiment. If a user selects the user interface control 302, the process for creating and monitoring a new mailing 116 is started and the routine 200 continues from operation 202 to operation 204.

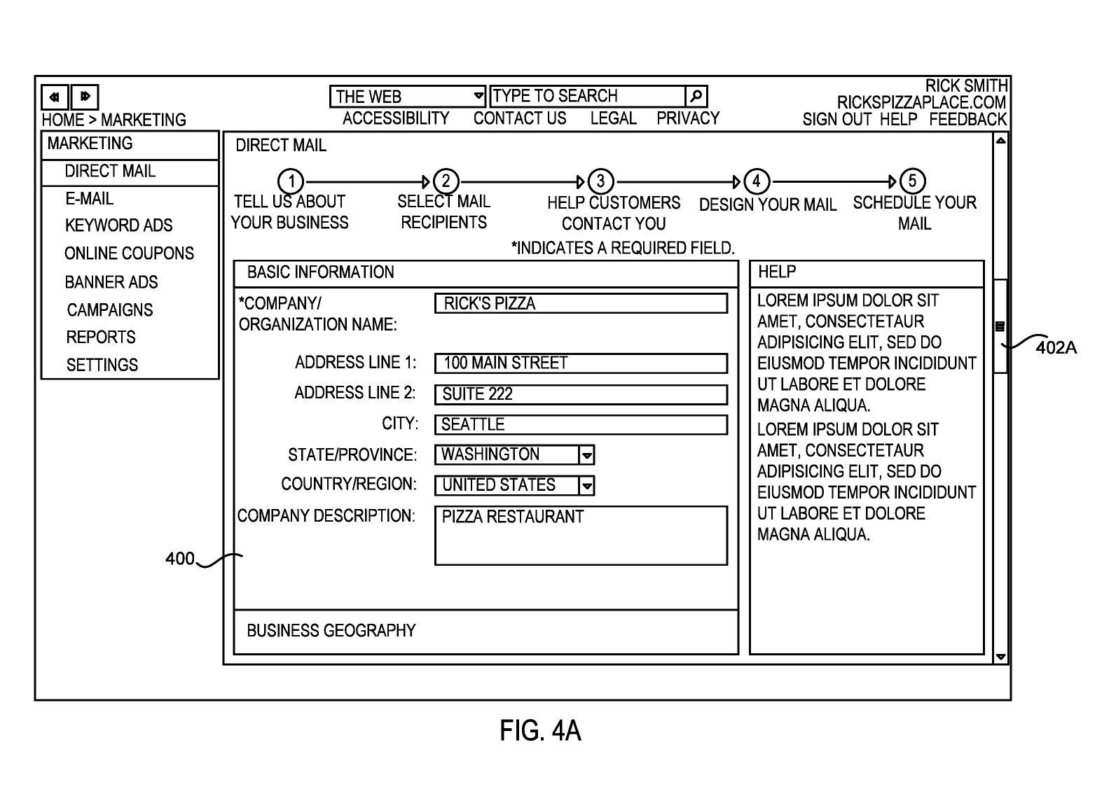

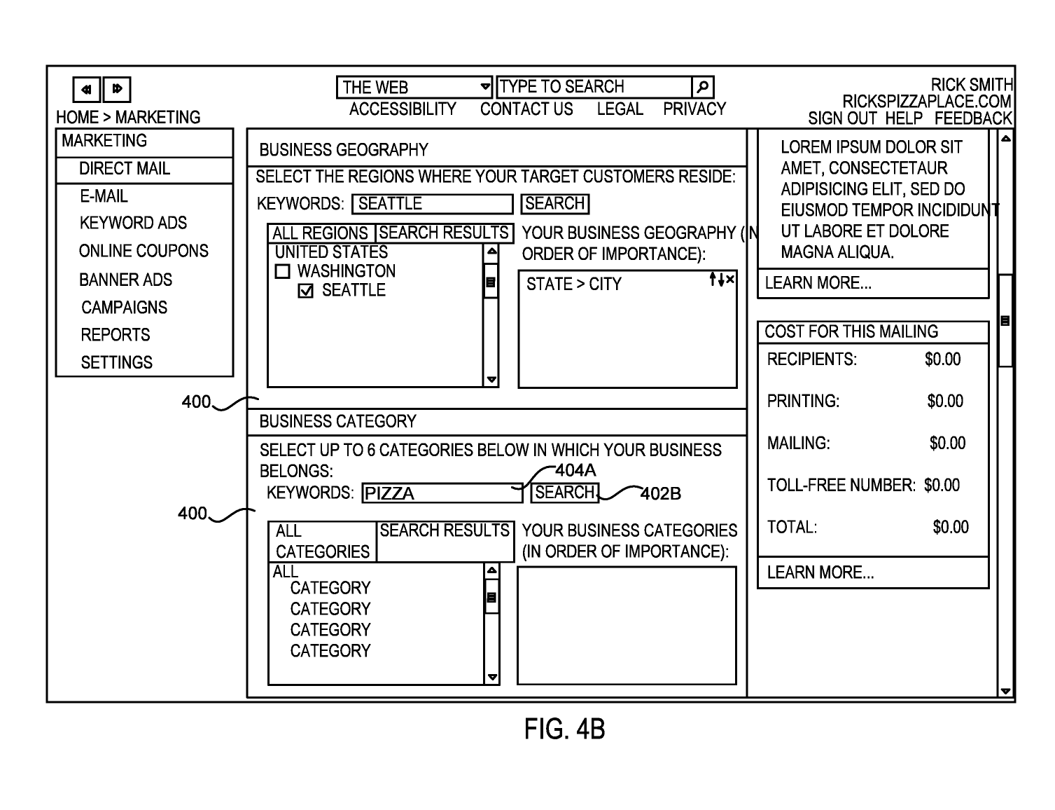

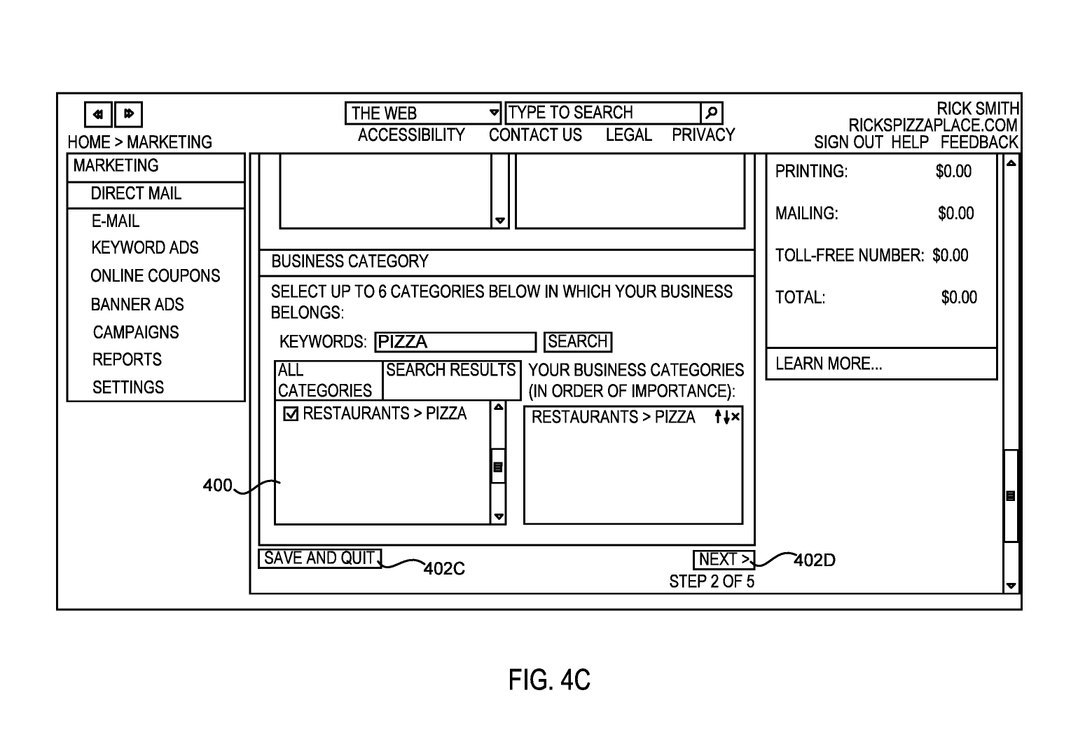

At operation 204, a user interface is provided for specifying information about a business 126 on behalf of which the mailing 116 is to be sent. For instance, according to one embodiment, a user interface is provided through which a user can specify contact information for the business, geographic information for potential customers of the business, and identify one or more categories to which the business belongs. This information is then received from a user via the user interface. FIGS. 4A-4C show an illustrative user interface provided by the Web site 104 in one embodiment for specifying information about a business on behalf of which a mailing is to be sent.

As shown in FIG. 4A, a user interface 400 is provided through which a user can provide the company name, address, and a description of the business. If the user selects the user interface control 402A, the user interface 400 may be scrolled to reveal the additional aspects shown in FIG. 4B. Through the portion of the user interface 400 shown in FIG. 4B, a user can specify geographic regions where customers of the business reside and select one or more categories to which the business belongs. A text box 404A may be provided to search the available categories. Selection of the user interface control 402B will cause the search to be performed.

In the example shown in the FIGURES, the business 126 that is creating the mailing 116 is a pizza restaurant called Rick's Pizza Place. In this example, a user has type the word “pizza” into the text box 404A to search for categories including this term. FIG. 4C shows the results of this search in the user interface 400, which indicate a category corresponding to pizza restaurants. The user has selected this category. As will be described in greater detail below, this information is utilized to generate demographic data corresponding to the potential customers of the pizza business. If the user then selects the user interface control 402C, the user can save the provided information and return to the process for creating the mailing 116 at another time. If the user then selects the user interface control 402D, the process for creating the mailing 116 will continue to the next step, which is described at operation 206 of the routine 200.

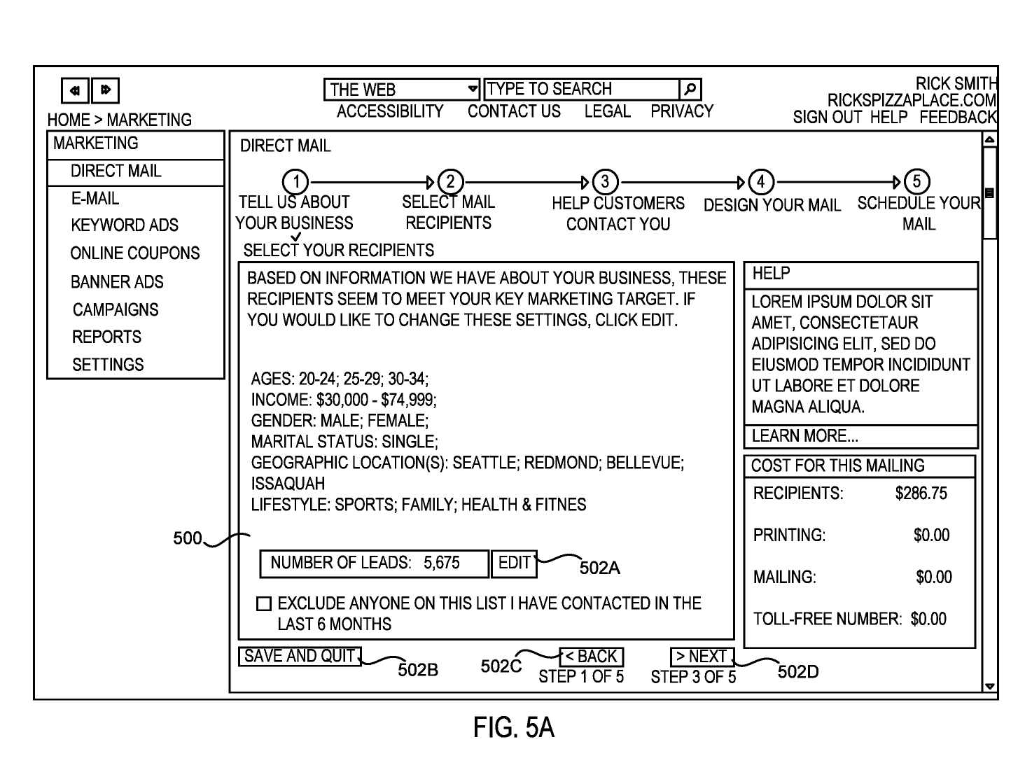

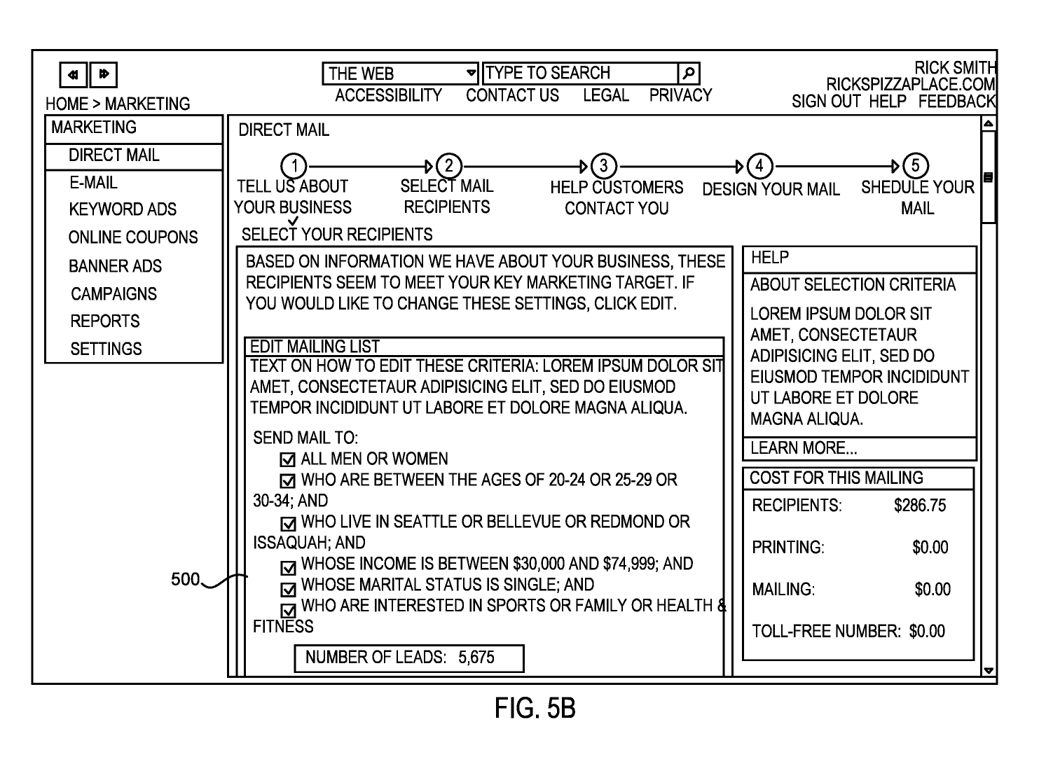

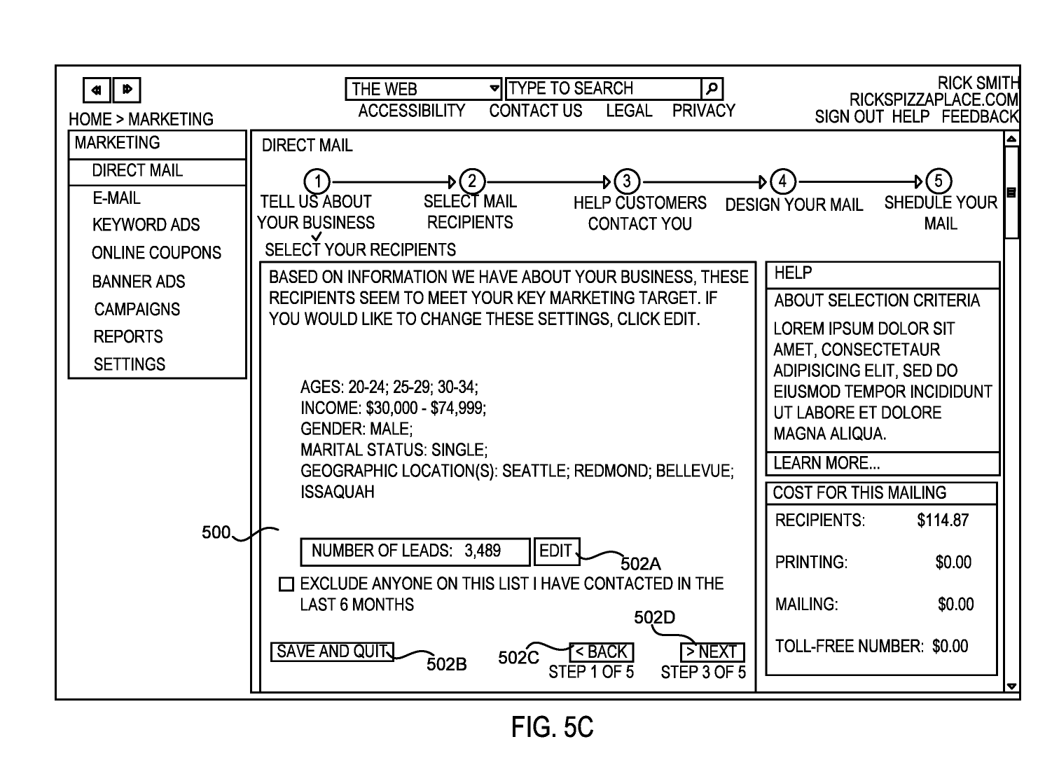

At operation 206, the Web site 104 generates demographic data corresponding to the potential customers 114 of the business 126 based upon the information provided about the business 126 at operation 204. As discussed above, the demographic data may be generated by the Web site 104 or by a third-party data provider 118. The demographic data is then presented to the user and the user is provided an opportunity to modify the demographic data. FIGS. 5A-5C show an illustrative user interface 500 provided by the Web site 104 for displaying the demographic data and allowing a user to modify the demographic data.

The user interface 500 shown in FIG. 5A displays the generated demographic data to a user. For example, in the example of Rick's Pizza Place, the targeted demographics are single males and females, having income between $30,000 and $74,999 per year, aged 20-34, located in Seattle, Redmond, Bellevue, and Issaquah, Wash., and having a sports, family, or health lifestyle. It should be appreciated that this demographic data is merely illustrative and that more or fewer demographics may be utilized.

According to one implementation, the number of potential customers may also be displayed to the user. In the example shown in FIG. 5A, there are 5,675 potential customers, or leads, based upon the specified demographics. The leads are identified based upon the generated demographic data. For instance, the data provider 118 may maintain a mailing database that can be searched based upon provided demographic data. The data provided by the data provider 118 includes appropriate contact information for each lead that is utilized to address the mailing 116 to the appropriate recipients.

Once the demographic data has been generated and presented, a user can select the user interface control 502B to save the information and return to the process for creating the mailing 116 at another time, select the user interface control 502C to return to the previous step of the process, or select the user interface control 502D to continue to the next step, which is described below with respect to FIG. 208. According to one implementation, the user may also be permitted to select the user interface control 502A for modifying the demographic data. If the user selects the user interface control 502A, a user interface is presented for modifying the demographic data and modifications to the demographic data are received from the user. One illustrative user interface for modifying the demographic data is shown in FIG. 5B.

As shown in FIG. 5B, the user interface 500 may be utilized to modify the demographic data. For instance, in this embodiment, a user desires to restrict the demographic data to men only. Accordingly, the user may utilize the user interface shown in FIG. 5B to make the modification. Once the modification has been completed, the user interface 500 shown in FIG. 5C is displayed. As shown in FIG. 5C, the modification is confirmed and the number of leads is updated. In this example, modification of the demographic data has reduced the number of leads from 5,657 to 3,489. The user may then select the user interface control 502A to make other modifications to the demographic data. The user may also select the user interface control 502B to save the information and return to the process for creating the mailing 116 at another time, select the user interface control 502C to return to the previous step of the process, or select the user interface control 502D to continue to operation 208 of the routine 200, which is described below.

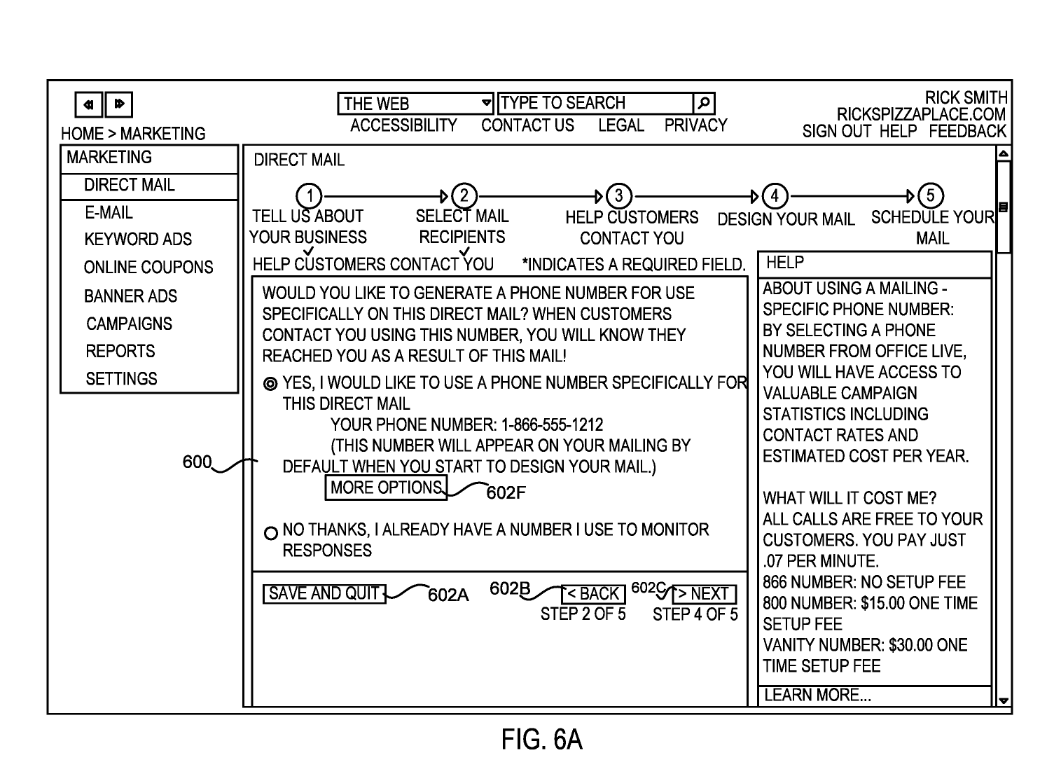

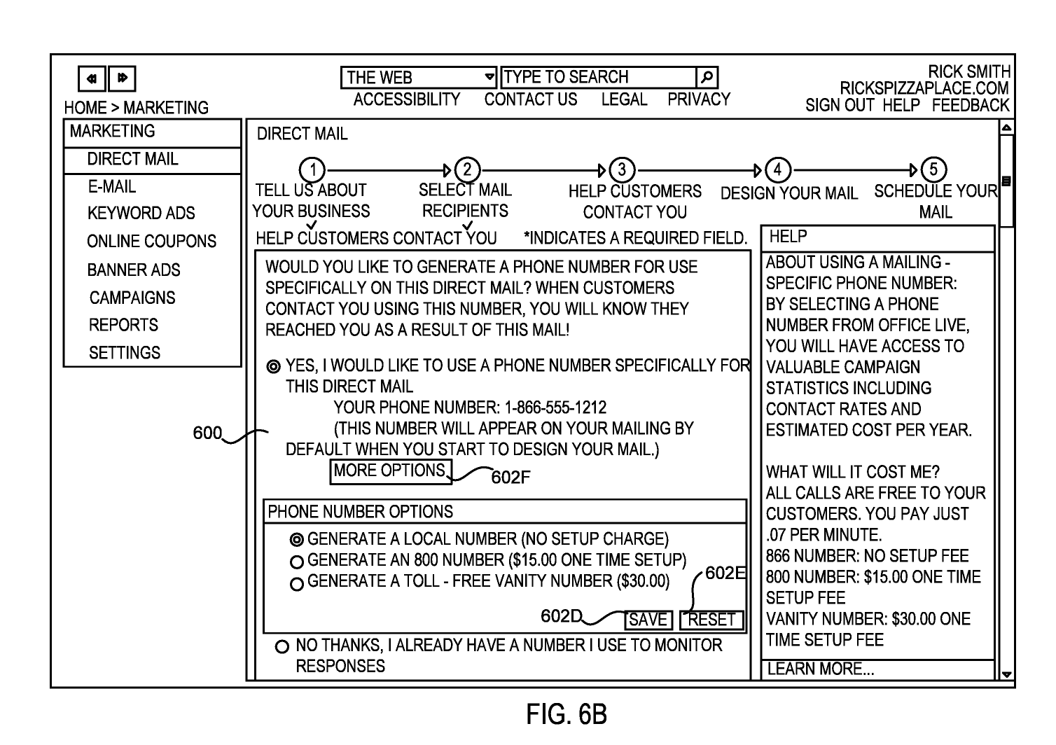

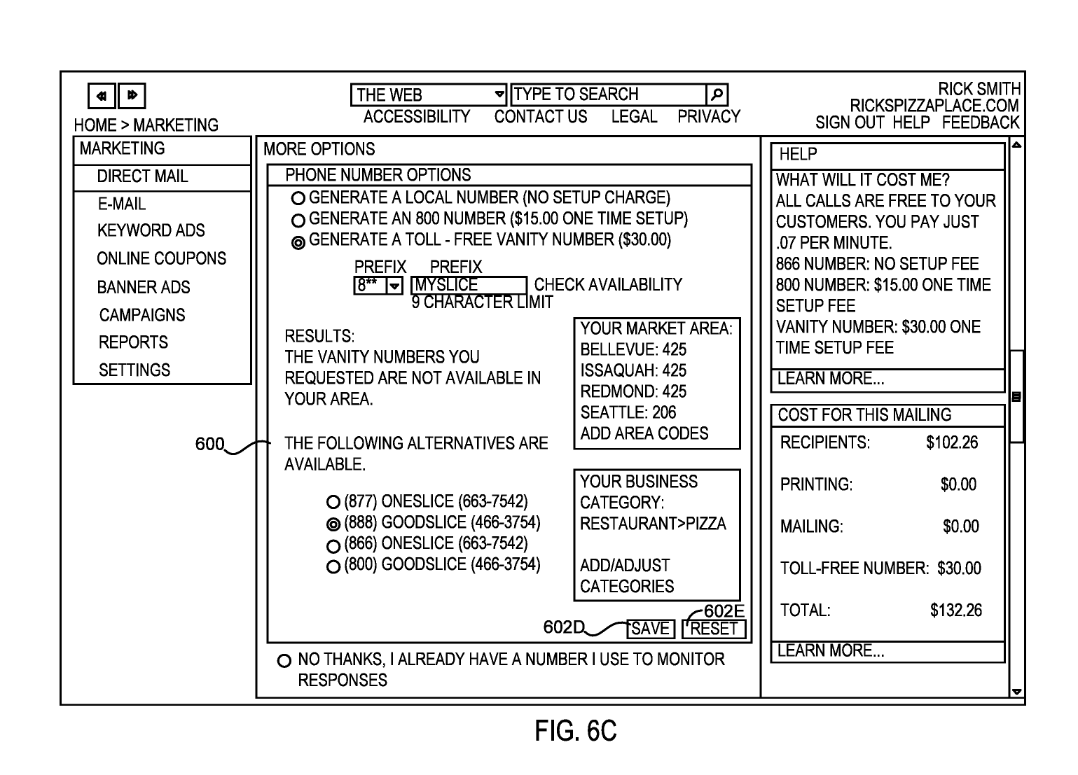

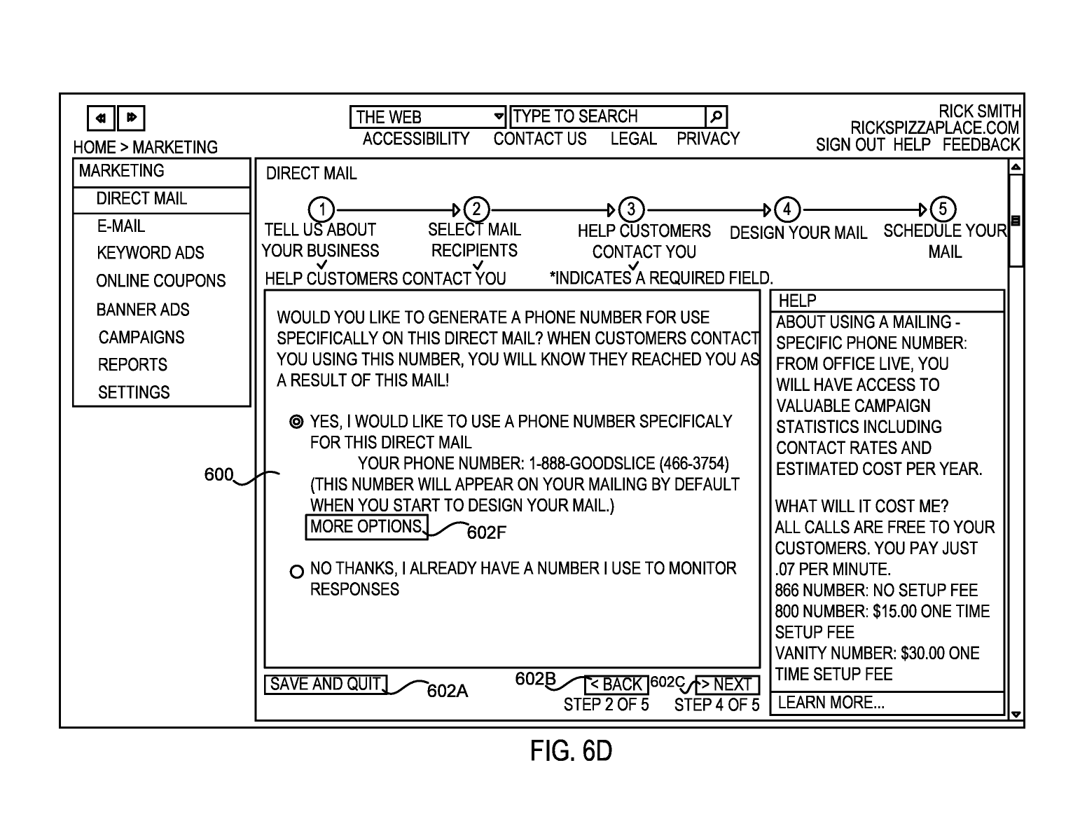

From operation 206, the routine 200 continues to operation 208, where a user interface is provided for allowing a user to specify a unique point of contact for customers to respond to the mailing 116. As discussed above, a unique point of contact is a mechanism for contacting the business 126 that is uniquely associated with a mailing 116. According to embodiments, the unique point of contact may comprise a unique telephone number associated with the mailing or a unique Web address associated with the mailing. FIGS. 6A-6D show an illustrative user interface provided by the Web site 104 for allowing a user to define a unique point of contact for the mailing 116. In this example, the unique point of contact 116 comprises a unique telephone number. It should be appreciated, however, that a similar user interface might be provided for allowing a user to specify a unique Web address associated with a mailing 116.

FIG. 6A shows a user interface 600 for defining a unique telephone number associated with the mailing 116. As discussed above, the telephone number appears on the mailing 116 and is utilized by the Web site 104 to track customer responses to the mailing 116. When the user interface 600 is initially presented, a telephone number associated with the mailing is generated and displayed to the user. The user may indicate through the user interface 600 that they already have a telephone number they will use to monitor responses. The user may also specify more options with respect to the generated telephone number through the selection of the user interface control 602F. The user may also select the user interface control 602A to save the information and return to the process for creating the mailing 116 at another time, select the user interface control 602B to return to the previous step of the process, or select the user interface control 602C to continue to the next step, which is described below.

If the user selects the user interface control 602F, the user interface 600 shown in FIG. 6B is displayed. Through this user interface, the user can indicate whether a local number should be generated for the mailing 116, whether a toll-free number should be generated for a fee, or whether a toll-free vanity number should be generated. The user may select the user interface control 602D to save the selection or the user interface control 602E to reset the user interface 600.

If the user indicates that a toll-free vanity number should be generated, the user interface shown in FIG. 6C is presented. Through this user interface, the user can specify the toll-free vanity number that they would like to use to monitor responses to the mailing 116. If the specified toll-free vanity number is not available, the Web site 104 may generate several alternative toll-free vanity numbers and display them to the user for selection. In the example shown in FIG. 6C, the user has indicated a desire for the toll-free vanity number 1-8XX-MYSLICE. This number, however, is unavailable. As a result, several alternatives that are available have been generated and presented to the user. The user has selected the toll-free vanity number 1-888-GOODSLICE. The user may select the user interface control 602D to save the selection or the user interface control 602E to reset the user interface 600. If the user selects the user interface control 602D to save the selection, the user interface shown in FIG. 6D is presented to the user to confirm the selection of the telephone number. As discussed above, the operations performed for generating and assigning a unique telephone number to a mailing 116 may be performed in conjunction with a telephony provider 120. Functions for monitoring calls received on the telephone number may also be performed by the telephony provider 120.

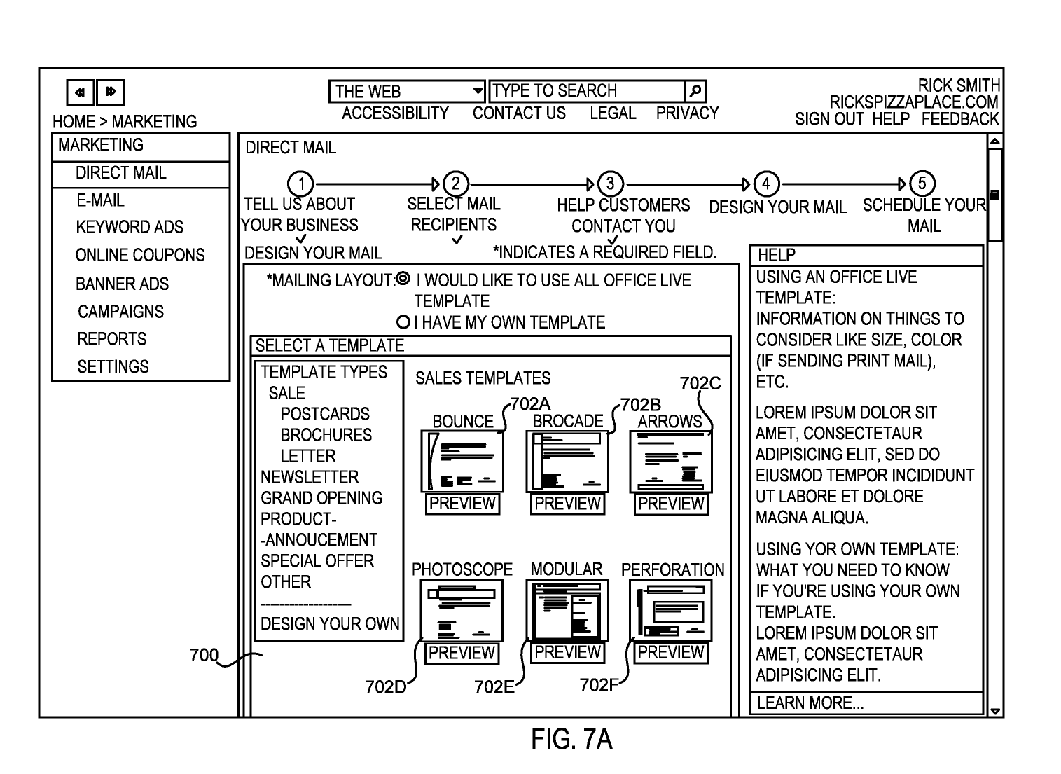

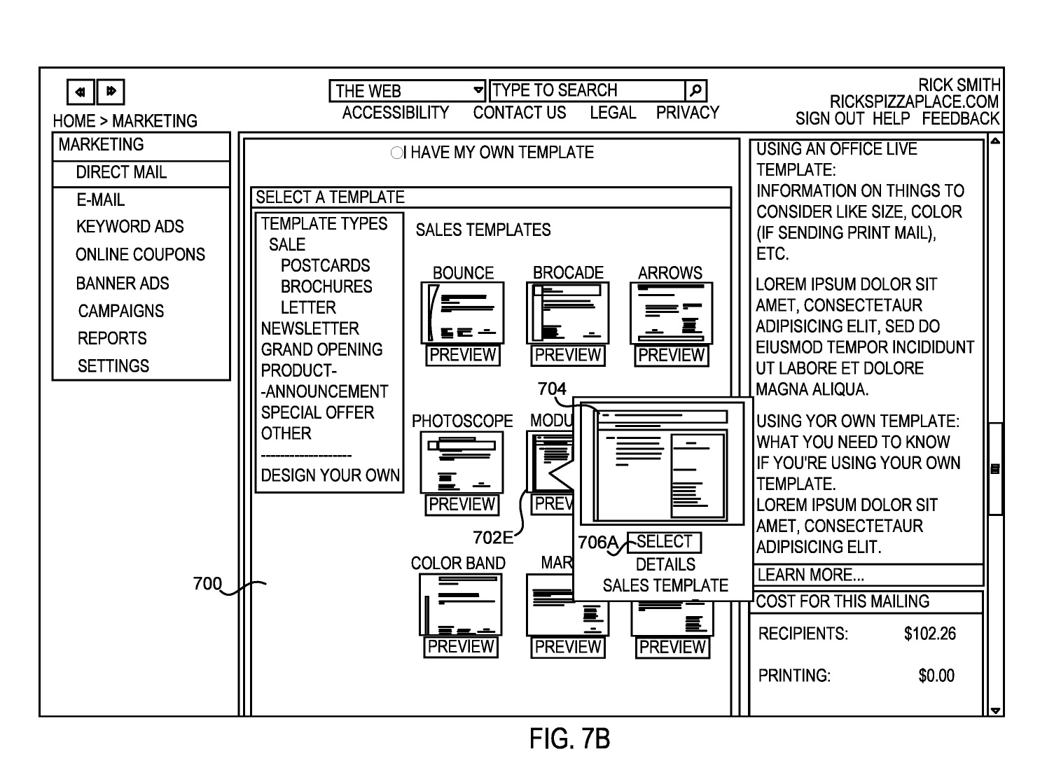

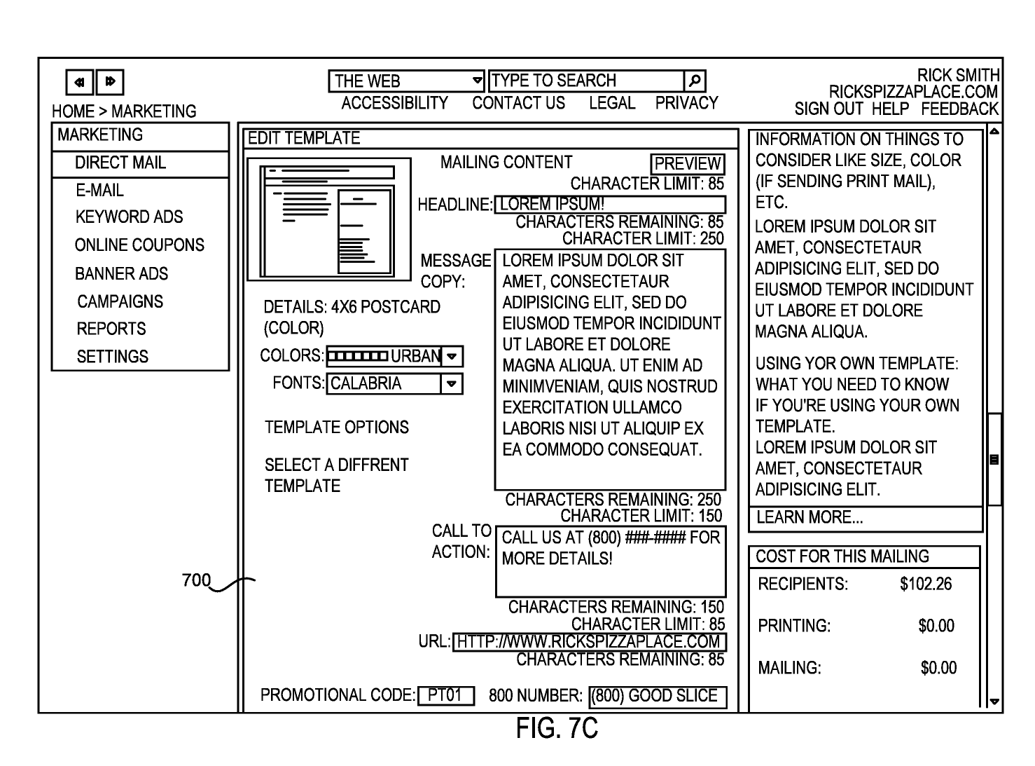

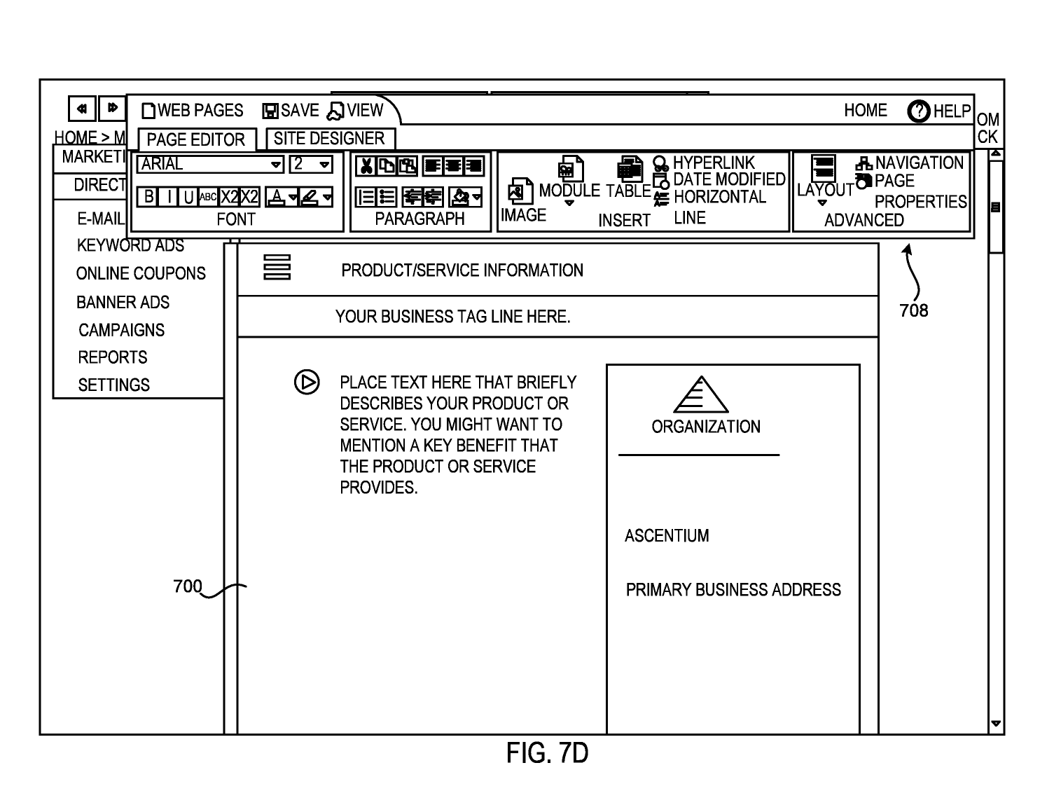

From operation 208, the routine 200 continues to operation 210, where a user interface is presented for specifying a layout and content for the mailing 116. For instance, in one implementation, a user interface is provided through which a user can select a pre-formed template for the mailing. The template includes a pre-defined layout and also specifies the visual style (e.g. font, colors, etc.) that should be used for the mailing 116. According to embodiments, the template may also include a pre-defined message and call to action for the mailing 116. For instance, the message may indicate that a sale is proceeding on a particular service or good and the call to action may request that the recipient call the generated telephone number associated with the mailing for more information. A user interface may also be provided that allows a user to modify the template, including modification of the message and the call to action. FIGS. 7A-7D illustrate such a user interface.

FIG. 7A shows aspects of an illustrative user interface 700 for selecting a template for the mailing 116. In the illustrative user interface 700 shown in FIG. 7, a number of user interface controls 702A-702F are displayed, each of which corresponds to an available template for the mailing 116. In this example, the user interface controls 702A-702F comprise selectable thumbnail renderings of the available templates. It should be appreciated, however, that other types of user interface controls might be utilized. If a user selects one of the user interface controls 702A-702F, additional details regarding the corresponding template will be provided. For instance, as shown in FIG. 7B, a larger preview 704 of the selected template may be displayed. The user may then select the user interface control 706A to utilize the selected template with the mailing 116.

In response to the selection of the user interface control 706A, the user interface 700 shown in FIG. 7C may be presented to the user. The user interface 700 shown in FIG. 7C includes functionality for modifying all aspects of the template, including a headline, the message copy, the call to action, the telephone number or Web address for responding to the mailing, and visual aspects such as the color or fonts utilized in the mailing. The user may also be permitted to perform what-you-see-is-what-you-get (“WYSIWYG”) editing on the template. This is illustrated in FIG. 7D. In the example shown in FIG. 7D, a tool palette 708 is provided through which a user may modify many properties of the selected template, including the text, font, font effects, document layout, paragraph layout, and other properties. Once the user has finished specifying the content for the mailing 116 and any modifications to the template, the routine 200 continues to operation 212.

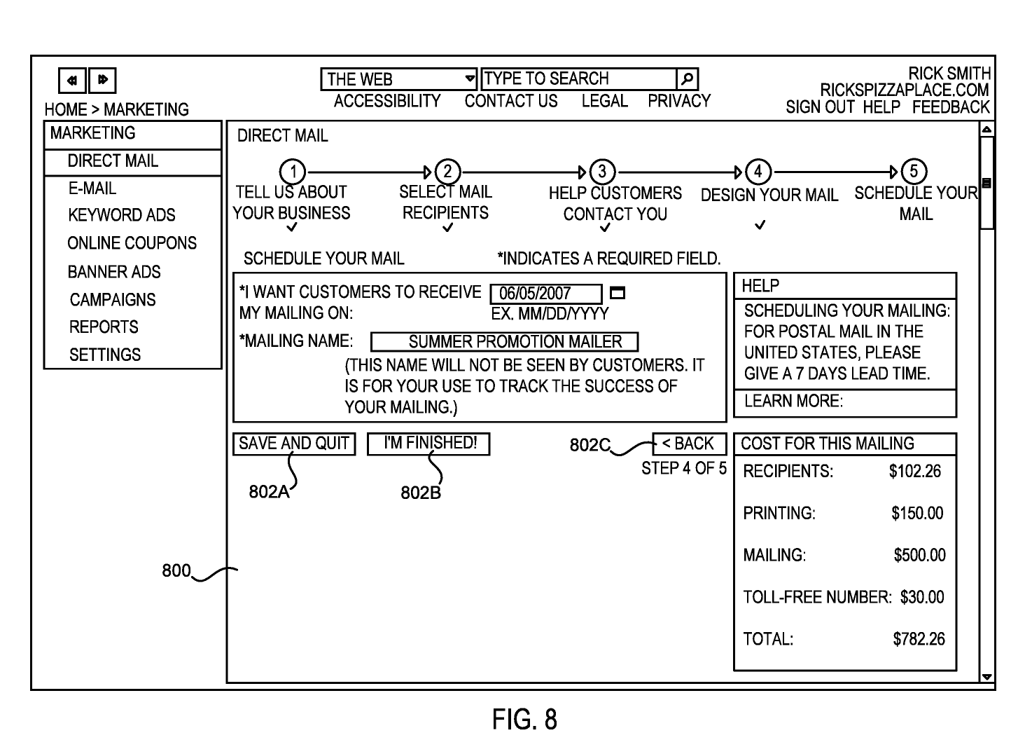

At operation 212, the Web site 104 provides a user interface through which a user can define a schedule for sending the mailing 116. For instance, through the user interface 800 shown in FIG. 8, a user can specify the date on which they would like the potential customers to receive the mailing 116. The user may then select the user interface control 802A to save the information and return to the process for creating the mailing 116 at another time, select the user interface control 802C to return to the previous step of the process, or select the user interface control 802B to finish the process and have the mailing 116 delivered to the recipients.

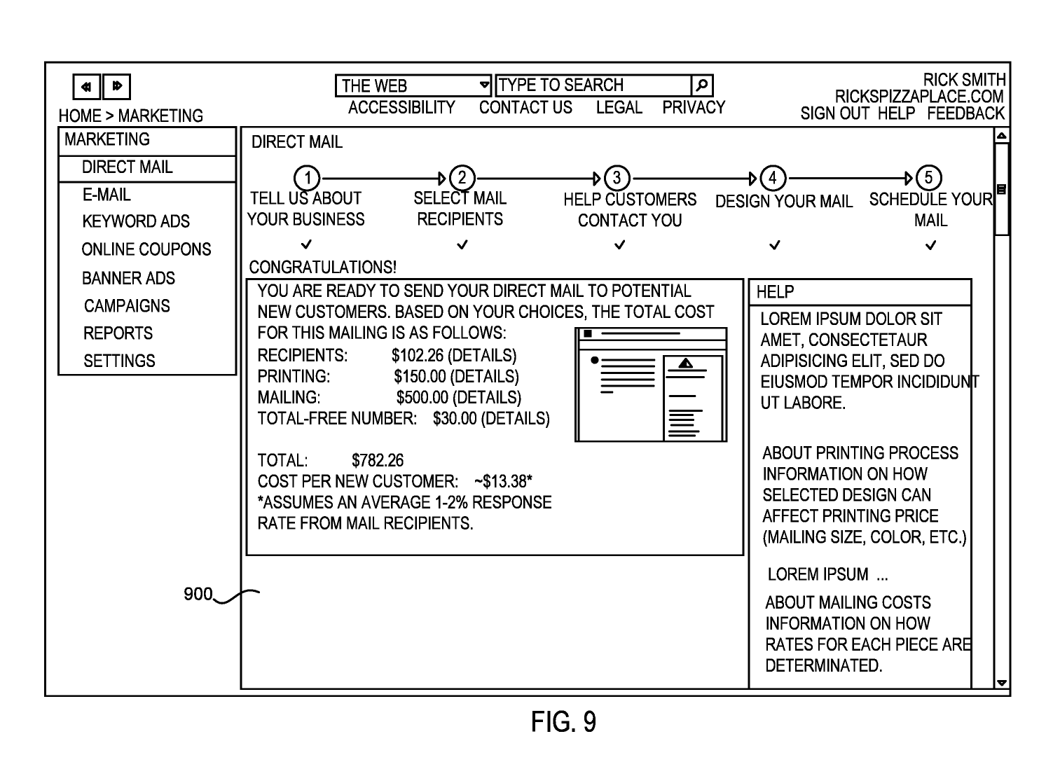

If the user elects to finish the mailing process, the routine 200 continues to operation 214, where a summary of the mailing is provided to the user. For instance, in one implementation, the user interface 900 shown in FIG. 9 is presented to the user, which includes a breakdown of the costs for the mailing. The mailing 116 is then sent to the potential customers 114 of the business 126 based upon the defined schedule. The mailing 116 is formatted according to the specified layout and includes the content defined by the user in the manner described above. As discussed briefly above, a third-party direct mail provider 122 may be utilized to send the mailing 116. In order to enable the direct mail provider 122 to send the mailing 116, data may be transmitted to the direct mail provider 122 identifying the intended recipients and specifying the layout and content for the mailing 116. Alternatively, the operator of the Web site 104 may send the mailing 116 directly.

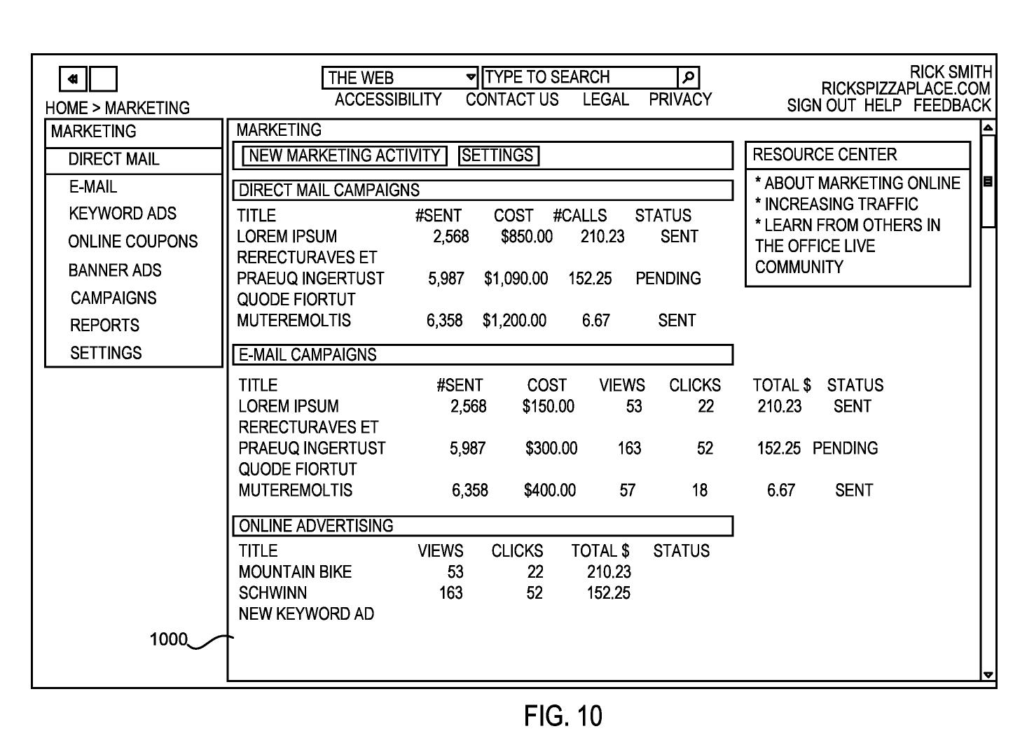

From operation 216, the routine 200 continues to operation 218, where the Web site 104 monitors the specified point of contact for the mailing to determine the number of responses to the mailing. For instance, a telephone number may be monitored to determine the number of calls received in response to the mailing and a Web address may be monitored to determine the number of requests received for the Web address in response to the mailing. A user interface, such as the user interface 1000 shown in FIG. 10, may be provided for delivering data to a user indicating the number of responses to the mailing made through the unique point of contact. From operation 218, the routine 200 continues to operation 220, where it ends. It should be appreciated that the routine 200 may be repeated indefinitely to define and implement multiple mail marketing campaigns.

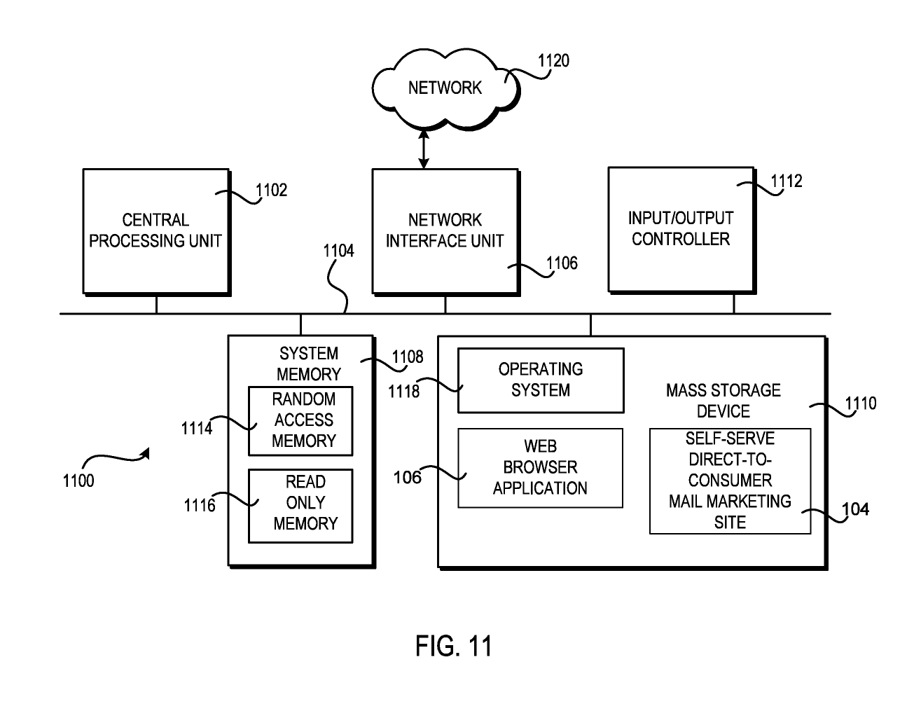

FIG. 11 shows an illustrative computer architecture for a computer 1100 capable of executing the software components described herein for generating and monitoring a mailing in the manner presented above. The computer architecture shown in FIG. 11 illustrates a conventional desktop, laptop, or server computer and may be utilized to execute any aspects of the software components described as executing on the client computer 108 or the server computer 102.

The computer architecture shown in FIG. 11 includes a central processing unit 1102 (“CPU”), a system memory 1108, including a random access memory 1114 (“RAM”) and a read-only memory (“ROM”) 1116, and a system bus 1104 that couples the memory to the CPU 1102. A basic input/output system containing the basic routines that help to transfer information between elements within the computer 1100, such as during startup, is stored in the ROM 1116. The computer 1100 further includes a mass storage device 1110 for storing an operating system 1118, application programs, and other program modules, which are described in greater detail herein.

The mass storage device 1110 is connected to the CPU 1102 through a mass storage controller (not shown) connected to the bus 1104. The mass storage device 1110 and its associated computer-readable media provide non-volatile storage for the computer 1100. Although the description of computer-readable media contained herein refers to a mass storage device, such as a hard disk or CD-ROM drive, it should be appreciated by those skilled in the art that computer-readable media can be any available computer storage media that can be accessed by the computer 1100.

By way of example, and not limitation, computer-readable media may include volatile and non-volatile, removable and non-removable media implemented in any method or technology for storage of information such as computer-readable instructions, data structures, program modules or other data. For example, computer-readable media includes, but is not limited to, RAM, ROM, EPROM, EEPROM, flash memory or other solid state memory technology, CD-ROM, digital versatile disks (“DVD”), HD-DVD, BLU-RAY, or other optical storage, magnetic cassettes, magnetic tape, magnetic disk storage or other magnetic storage devices, or any other medium which can be used to store the desired information and which can be accessed by the computer 1100.

According to various embodiments, the computer 1100 may operate in a networked environment using logical connections to remote computers through a network such as the network 1120. The computer 1100 may connect to the network 1120 through a network interface unit 1106 connected to the bus 1104. It should be appreciated that the network interface unit 1106 may also be utilized to connect to other types of networks and remote computer systems. The computer 1100 may also include an input/output controller 1112 for receiving and processing input from a number of other devices, including a keyboard, mouse, or electronic stylus (not shown in FIG. 11). Similarly, an input/output controller may provide output to a display screen, a printer, or other type of output device (also not shown in FIG. 11).

As mentioned briefly above, a number of program modules and data files may be stored in the mass storage device 1110 and RAM 1114 of the computer 1100, including an operating system 1118 suitable for controlling the operation of a networked desktop, laptop, or server computer. The mass storage device 1110 and RAM 1114 may also store one or more program modules. In particular, the mass storage device 1110 and the RAM 1114 may store the Web browser application 106 and the Web site 104, each of which was described in detail above with respect to FIGS. 1-10. The mass storage device 1110 and the RAM 1114 may also store other types of program modules.

Based on the foregoing, it should be appreciated that technologies are disclosed herein for providing a self-serve direct-to-consumer mail marketing service. Although the subject matter presented herein has been described in language specific to computer structural features, methodological acts, and computer readable media, it is to be understood that the invention defined in the appended claims is not necessarily limited to the specific features, acts, or media described herein. Rather, the specific features, acts and mediums are disclosed as example forms of implementing the claims.

The subject matter described above is provided by way of illustration only and should not be construed as limiting. Various modifications and changes may be made to the subject matter described herein without following the example embodiments and applications illustrated and described, and without departing from the true spirit and scope of the present invention, which is set forth in the following claims.

What is claimed is:

1. A method for providing a self-serve direct-to-consumer mail marketing service, the method comprising:
providing a first user interface for specifying information about a business on behalf of which a mailing is to be sent;
receiving the information about the business via the first user interface;
generating demographic data corresponding to one or more potential customers of the business, the demographic data being generated based upon the information about the business supplied via the first user interface;
identifying the one or more potential customers of the business based upon the generated demographic data;
providing a second user interface for specifying a layout and content for the mailing;
receiving a layout and content for the mailing via the second user interface;
providing a third user interface for defining a schedule for sending the mailing; and
sending the mailing to the one or more potential customers of the business based upon the schedule, the mailing comprising the layout and content defined utilizing the second user interface.

2. The method of claim 1, wherein the information about the business received on the first user interface comprises contact information for the business, geographic information for the one or more potential customers of the business, and one or more categories to which the business belongs.

3. The method of claim 1, further comprising following generating demographic data corresponding to a group of potential customers of the business:
providing a fourth user interface through which a user can modify the demographic data; and
receiving one or more modifications to the demographic data through the fourth user interface.

4. The method of claim 1, wherein the second user interface for specifying a layout and content for the mailing comprises a user interface through which a user can select a template for the mailing, the template comprising content including a pre-defined message and call to action.

5. The method of claim 1, further comprising:
providing a fifth user interface for defining a unique point of contact for the mailing; and
receiving input via the fifth user interface defining the unique point of contact for the mailing.

6. The method of claim 5, wherein the unique point of contact for the mailing comprises a telephone number associated with the mailing.

7. The method of claim 6, further comprising:
monitoring the telephone number to determine a number of calls received on the telephone number; and
providing a sixth user interface for indicating the number of calls received on the telephone number.

8. The method of claim 5, wherein the unique point of contact comprises a unique World Wide Web (Web) address associated with the mailing.

9. The method of claim 8, further comprising:
monitoring the Web address to determine a number of requests received for the Web address; and
providing a sixth user interface for indicating the number of requests received for the Web address.

10. A computer storage medium having computer-executable instructions stored thereon which, when executed by a computer, cause the computer to:
receive input defining information about a business on behalf of which a mailing is to be sent;
generate demographic data corresponding to a group of potential customers of the business based upon the received information about the business;
identify one or more potential customers of the business based upon the generated demographic data;
receive input defining a layout and content for the mailing;
receive input defining a schedule for sending the mailing; and to
send the mailing to the one or more potential customers of the business based upon the schedule, the mailing comprising the layout and content.

11. The computer storage medium of claim 10 comprising further computer-executable instructions which, when executed by the computer, cause the computer to receive input defining a unique point of contact associated with the mailing.

12. The computer storage medium of claim 11 comprising further computer-executable instructions which, when executed by the computer, cause the computer to monitor the point of contact to determine a number of responses to the mailing.

13. The computer storage medium of claim 12, wherein the unique point of contact associated with the mailing comprises a unique telephone number associated with the mailing.

14. The computer storage medium of claim 13, wherein the mailing comprises one of a postal mailing or an electronic mailing.

15. The computer storage medium of claim 14, comprising further computer-executable instructions which, when executed by the computer, cause the computer to receive input defining one or more modifications to the generated demographic data.

16. The computer storage medium of claim 15, wherein the information about the business comprises contact information for the business, geographic information for the one or more potential customers of the business, and one or more categories to which the business belongs.

17. The computer storage medium of claim 16, wherein the computer-executable instructions which, when executed by the computer, cause the computer to receive input defining a layout and content for the mailing by receiving input defining a template for the mailing, the template comprising content including a pre-defined message and call to action.

18. A method for providing a self-serve direct-to-consumer mail marketing service, the method comprising:
receiving a request to generate a mailing;
in response to receiving the request, providing a unified World Wide Web (Web) site operative to receive input defining information about a business on behalf of which the mailing is to be sent, to generate demographic data corresponding to a group of potential customers of the business based upon the received information about the business, to identify one or more potential customers of the business based upon the generated demographic data, to receive input defining a layout and content for the mailing, to receive input defining a unique point of contact associated with the mailing, to receive input defining a schedule for sending the mailing, to send the mailing to the one or more potential customers of the business based upon the schedule, and to monitor the point of contact to determine a number of responses to the mailing.

19. The method of claim 18, wherein the mailing comprises one of a postal mailing or an electronic mail mailing.

20. The method of claim 19, wherein the unique point of contact comprises one of a unique telephone number associated with the mailing or a unique Web address associated with the mailing.
